(19) United States
(12) Patent Application Publication
(10) Pub. No.: US 2019/0236498 A1
(43) Pub. Date: Aug. 1, 2019

(54) PREDICTIVE UAV PACKAGE DELIVERY SYSTEM

(71) Applicant: Walmart Apollo, LLC, Bentonville, AR (US)

(72) Inventors: Robert CANTRELL, Herndon, VA (US); Donald R. HIGH, Noel, MO (US); John J. O'BRIEN, Farmington, AR (US); Brian MCHALE, Oldham (GB); Todd MATTINGLY, Bentonville, AR (US)

(73) Assignee: Walmart Apollo, LLC, Bentonville, AR (US)

(21) Appl. No.: 16/262,500

(22) Filed: Jan. 30, 2019

Related U.S. Application Data
(60) Provisional application No. 62/624,682, filed on Jan. 31, 2018.

(51) Int. Cl. G06Q 10/04; G06Q 10/08; G06Q 20/40; G06Q 30/06; B64C 39/02

(52) U.S. Cl. CPC G06Q 10/047; G06Q 10/083; G06Q 20/40145; G06Q 30/0603; B64C 2201/145; B64C 2201/128; B64C 2201/123; B64C 2201/127; B64C 39/024

(57) ABSTRACT

A method and system for predictive package delivery. The method and system include loading a product onto a unmanned aerial vehicle (UAV), launching the UAV and navigating the UAV to a delivery location, communicating to a portable device of a consumer at the delivery location the product loaded into the UAV, preventing interception of the package by a third party, and delivering the product to the consumer after the consumer purchases the product with the portable device. The product is selected based on a prediction of high demand products for the delivery location. The delivery of the product comprises sensing the consumer is in the receiving position and then lowering the product to the consumer.

### CROSS REFERENCE TO RELATED APPLICATIONS

This present patent application claims priority benefit from U.S. Provisional Patent Application No. 62/624,682 filed on Jan. 31, 2018, the entire content of which is hereby incorporated herein by reference.

### TECHNICAL FIELD OF THE INVENTION

The present application relates to delivering packages with an unmanned vehicle. More specifically, the present application relates to a system and method for predictive unmanned aerial package delivery.

### BACKGROUND OF THE INVENTION

There is a critical mass of consumers and packages to be reached to ensure an aerial vehicle package delivery system provides a sustainably profitable program. A profitable program under current cost models assumes that an aerial vehicle, such as an unmanned aerial vehicle (UAV) will be working most hours of the day to offset the cost of given deliveries, the depreciation assigned to the UAV, and the cost of supporting operations. Currently, aerial vehicle package delivery, specifically, UAV package delivery is based entirely on a “pull system.” That is, the UAV waits for an order from a consumer before launching with the package for delivery. Sometimes, online consumers may be pushed, that is, the online consumers are provided messages and incentives to encourage purchases. The pushed purchases may assist in keeping a delivery cue full for a UAV. However, the “pull system” and the pushed purchases may not fill a delivery cue and may not result in a profitable UAV package delivery program.

Therefore, there is a need for maintaining a UAV constantly in flight and delivery mode such that the UAV may deliver profits even if they lack immediate orders. A system and method for the UAV to fly on a delivery before an order is received so the UAVs spend minimal time idling is needed.

### BRIEF SUMMARY

According to an embodiment of the present disclosure, a method for delivering a package may include loading a product onto a unmanned aerial vehicle (UAV), launching the UAV and navigating the UAV to a delivery location, communicating to a mobile device of a consumer at the delivery location the product loaded into the UAV, preventing interception of the package by a third party, and delivering the product to the consumer after the consumer purchases the product with the mobile device. The product is selected based on a prediction of high demand products for the delivery location. The product comprises sensing the consumer is in the receiving position and then lowering the product to the consumer.

According to an embodiment of the present disclosure, a method for delivering a package may include loading a first product and a second product onto a unmanned aerial vehicle (UAV); navigating the UAV to a first delivery location; communicating to a consumer at the first delivery location that delivery of the first product is imminent; preventing interception of the first product by a third party; delivering the first product to the consumer; navigating the UAV to a second delivery location; communicating to one or more second consumers that the second product is available for purchase; and delivering the second product to one of the one or more second consumer at the second delivery location after purchase of the second product by the one of the one or more second consumers. The second product, the second delivery location, or both are selected to optimize the profitability of the UAV and based on the probable value of purchase and delivery of the second product.

### BRIEF DESCRIPTION OF DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a flow diagram for an exemplary predicative aerial vehicle delivery system, according to an embodiment of the present disclosure;

FIG. 2. shows a schematic of an aerial vehicle, according to an embodiment of the present disclosure;

FIG. 3 shows a schematic of a delivery arrangement of an aerial vehicle, according to an embodiment of the present disclosure;

FIG. 4 shows a schematic of a delivery arrangement of an aerial vehicle, according to an embodiment of the present disclosure;

FIG. 5 shows a schematic of a delivery arrangement of an aerial vehicle, according to an embodiment of the present disclosure;

FIG. 6 shows a schematic of user recognition by the aerial vehicle, according to an embodiment of the present disclosure;

FIG. 7 shows a schematic of user recognition by the aerial vehicle, according to an embodiment of the present disclosure;

FIG. 8 shows a schematic of a perch for use with an aerial vehicle, according to an embodiment of the present disclosure;

FIG. 9 shows a schematic of a mobile application for use with an aerial vehicle, according to an embodiment of the present disclosure;

FIG. 10 shows a schematic of a mobile application for use with an aerial vehicle, according to an embodiment of the present disclosure;

FIG. 11 shows a schematic of a mobile application for use with an aerial vehicle, according to an embodiment of the present disclosure; and

FIG. 12 shows a block diagram of a predictive aerial vehicle delivery system, according to an embodiment of the present disclosure.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art would recognize that other equivalent parts can be employed and other methods developed without departing from the spirit and scope of the invention. All references cited herein are incorporated by reference as if each had been individually incorporated.

The present disclosure relates to launching aerial vehicles, such as UAVs or drones, bearing high-demand or impulse products. The high-demand or impulse products are selected such that they have a high likelihood of being sold to consumers along the route of the aerial vehicle. The aerial vehicle may be already delivering packages to one or more destinations (e.g. delivering a traditional online order) and the impulse products may be loaded into empty areas of the cargo hold. In other cases, the aerial vehicle may be stocked solely with impulse products and launched to fly a predetermined route.

The present disclosure also relates to aerial vehicles that may be launched with products likely to be purchased on impulse and directed to places, events, or venues where impulse purchases are likely to be placed (e.g. parks, beaches, outdoor events, etc.). At the event or location, a consumer may view an application (“app”) on their mobile device. The app may display aerial vehicles in the location of the consumer and the contents of the aerial vehicles. The consumer may purchase a product via the app from one of these aerial vehicles via the mobile device app and take delivery of the product in short order.

The present disclosure also relates to delivery of the product after purchasing by the consumer. The aerial vehicles may aim for the mobile device which purchased the product and locate a suitable landing location or drop the product to the consumer's hands when the consumer is presenting their arms and body in a designated delivery position. The aerial vehicle may have a cable, parachute, cushioned package, or landing pad for delivery of the product.

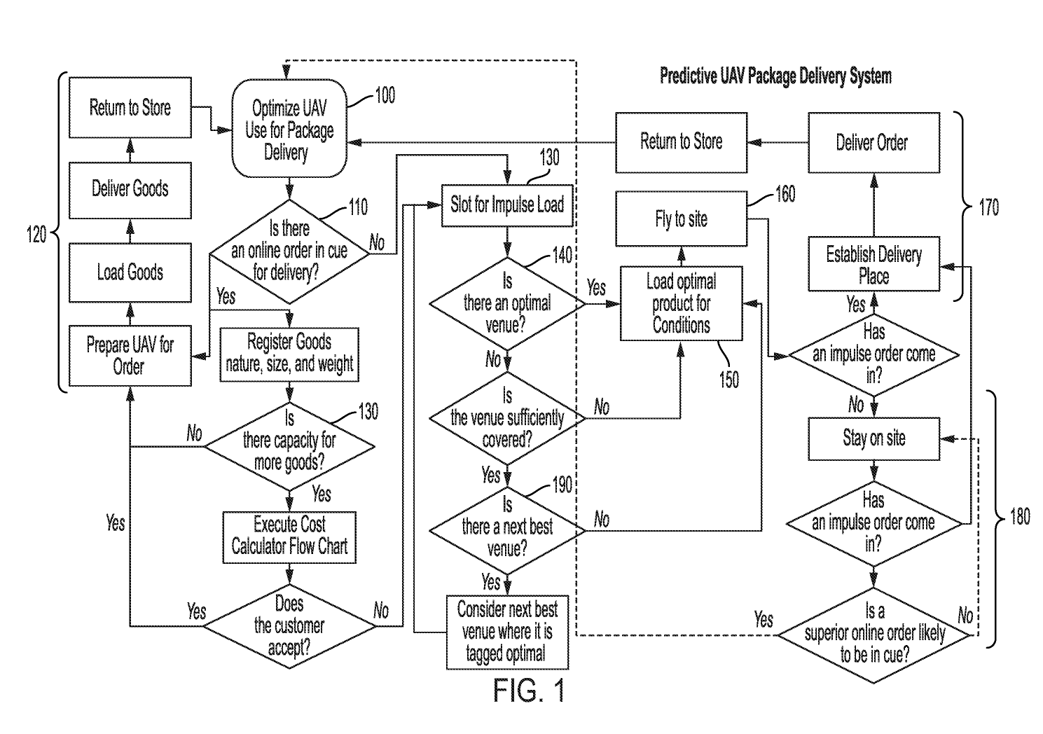

Referring to FIG. 1, an exemplary process of the predictive aerial vehicle package delivery system is shown. At step 100, the system may begin to optimize the aerial vehicle for package delivery. A fleet of aerial vehicles needs to be sorted, loaded, and launched to deliver both online and impulse purchases. The exemplary process optimizes the fleet of aerial vehicles such that the profitability of an aerial vehicle package delivery fleet may be maximized.

Optimizing in step 100 may refer to optimizing the payload. That is, the objective may be to maximize the revenue delivered by each aerial vehicle and/or the fleet of aerial vehicles. There may be two primary variables a known variable (a) and a probable variable (b). Delivery of a good ordered online presents the known variable (a), while delivery of an impulse item creates the probable variable (b). Any given aerial vehicle may not have enough (a) variables to keep the aerial vehicle in service (e.g., flying) all day. In that case, the aerial vehicle may pursue (b) variables when the probable value of the (b) variable is highest as weighed against the (a) variables. In some cases, this may result in all (a) variables being delivered before the aerial vehicle proceeds with (b) variables. In other cases, not all (a) variables may be delivered prior to proceeding with (b) variables.

For example, an aerial vehicle may deliver all (a) variables during mid-morning and mid-afternoon, but may set out with some (b) variables during the lunch hour when the probability of an impulse order is higher. The aerial vehicle may carry one product or may carry several. In another example, the aerial vehicle may carry both (a) variable items and (b) variable items, if the space is available, to benefit from the possibility an impulse order (e.g., (b) variable item) may be ordered while the aerial vehicle is in route to deliver (or return from delivery) of an online order (e.g., (a) variable item). This may raise the value of that flight.

At step 110, the system determines if there is a previously scheduled delivery (such as, for example, a conventional online order or (a) variable order) for the particular aerial vehicle being optimized. If there is an order, and in accordance with step 120, the aerial vehicle may be loaded with the online order, deliver the online order, and return to the base (e.g. warehouse) to re-enter the cue of aerial vehicles in the fleet being scheduled for delivery.

At step 130, it may be determined that there is a conventional online order to be delivered and it may also be determined that there is additional space in the cargo hold to load an impulse purchase. The system may determine in step 140 if there is a location (e.g. venue) located near or along the flight route of delivery of the package being delivered. A location or “optimal venue” may be considered a location which is likely to have a high density of impulse purchasers (e.g., (b) variable items), located sufficiently close to the previously scheduled delivery route to minimize delay, and/or a location where the likelihood of selling an impulse product in an amount of time to render the additional cargo and additional flight time profitable. If a location is found along or near the delivery route, at step 150, one or more impulse products may be loaded onto the aerial vehicle, the aerial vehicle is launched at 160 to fly to the “optimal venue” and wait until purchase of the impulse product in either of the manners described in steps 170 and 180 or until the aerial vehicle must leave to complete its delivery (e.g. running low on power). After delivery of the one or more impulse products, the aerial vehicle may proceed to delivery of the online order and return to the base to re-enter the cue of aerial vehicles to be scheduled for delivery of an impulse run.

It may be appreciated that steps 130-180 may also occur if there is no conventional online order (e.g., (a) variable order). In this case, the aerial vehicle may be loaded with one or more impulse products. Determination of an “optimal venue” and product(s) may include consideration of highly purchased items for a particular time, place, event, or environmental condition, as will be described in more detail to follow. When the aerial vehicle has waited for purchase as described in steps 170 or 180, the aerial vehicle return to the base to re-enter the cue of aerial vehicles to be scheduled for delivery of an impulse run or online order.

Returning to step 130, if an “optimal venue” is not found, or if the venue is not sufficiently covered for the sale and delivery of the one or more impulse products, a next best venue maybe determined at step 190 using the same or similar parameters as the “optimal venue,” as described herein. After the determination of the next best venue, steps 150-180 may occur as previously described. It may be appreciated that the consideration of “next best” venue may occur if no venue is found until it is determined there is not a venue for selling impulse products that will make an impulse run of the aerial vehicle profitable. In this situation, the aerial vehicle may be tasked for online order delivery or to wait in line of the cue of aerial vehicles for delivery.

As may be appreciated, this cycle may continue for a particular delivery time period of the fleet of aerial vehicles. Each aerial vehicle launched from the base may be optimized to carry the most cargo, between online orders ((a) variables) and impulse runs ((b) variables), to maximize the profitability of each aerial vehicle flight. The profitability of each flight may be determined based on the cost of given deliveries (online or impulse), the depreciation assigned to the UAV, the cost of supporting operations, and/or the cost of the particular flight (including downtime and fuel costs), etc. Additional considerations of valuation and profitability may include, but are not limited to, vehicle (availability, condition, usage, size, etc.), battery, station (location), energy, personnel, packaging, 3^{rd} party operator fees, tracking fees, UTM fees, premiums or discounts based on service level, insurance, etc.

Additional considerations for what impulse products should be carried and/or whether an aerial vehicle should make an impulse run may include, for example, but not limited to, locations (such as a popular park where people eat lunch, a beach, etc.), distance from the store (e.g., less time is spent flying to and from the store), type of good for the particular location (e.g., sunscreen for a beach), time of day (e.g., lunch items around noon), weather (e.g., sunscreen or umbrellas for hot days or rainy days, respectively), physical risk factors (e.g., more or fewer obstacles in a park versus a beach), statistics, the 5Ws on past orders (e.g., who, what where, when, why, how). This may involve strategic factors such as space, time, material, and risk, each variable may influence the other and the system of FIG. 1 may maximizing the sum of the (a) variables and (b) variables for each aerial vehicle and the fleet.

With continued reference to the exemplary delivery program of FIG. 1, the system may have rules to predict impulse products, locations, flight patterns and/or delivery routes. The rules may be based on data given a particular regions, locals, and consumers in those regions. The rules may be based on the market as a whole via observation and/or data. For example, certain products may be highly purchased in a particular location. The system may also consider a variety of factors when determining valuation of the impulse flight to determine profitability of the flight. The valuation considerations may be length of time, cost of flight, value of the impulse order, and/or value of customer satisfaction.

Impulse Products

High-demand or impulse products ((b) variables) may be consumables, such as food, snacks, or beverages, etc. Impulse products may be other consumer goods such as suntan lotion, books, ponchos, umbrellas, personal fans, chap stick, etc. Impulse products may be products tailored to a particular location or weather condition, such as suntan lotion for a beach, ponchos or umbrellas for rainy weather, etc. The impulse products may be selected based on data indicative of highly purchased items for a particular time, place, event, or environmental condition. Certain products, when ordered regularly, may become impulse products. For example, sodas, may be launched in anticipation of receiving the regular order, with the high probability that if a given order does not arrive that day, or the consumer does not respond to an alert, the product may likely be sold on impulse to another consumer nearby. Likely impulse products may be determined based on weight, cost, profit to be obtained, cost of the original product, etc.

Impulse products include, for example, on a hot summer day, cold beverages, sodas, water or cold treats, such as ice cream or popsicles. For example, if the weather changes or is predicted to change to begin raining in a particular location, an aerial vehicle may be preloaded with ponchos and/or umbrellas. For example, an aerial vehicle may be preloaded with suntan lotion and navigated to the beach for consumers who forgot or ran out of suntan lotion. For example, around lunch time, the aerial vehicle may be preloaded with sandwiches, salads, and beverages, etc. toward office complexes or parks. Additionally, a consumer may preorder a lunch meal that is delivered via the aerial vehicle at a particular time to a particular location. The aerial vehicles that may have orders in the cue may be requisitioned for the lunch service demand if orders in the cue may wait for delivery until after the high rush period of lunch is completed.

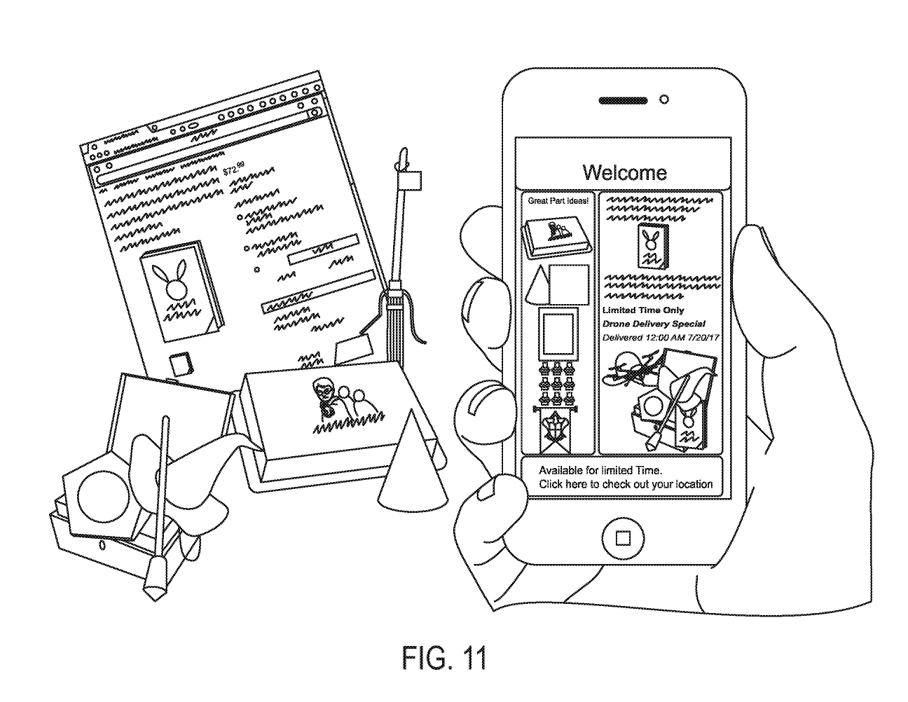

The impulse product may be determined based on a particular upcoming event, such as a book launch or new electronic device launch. For example, see FIG. 11, if a book, phone, or other product is released at midnight at particular brick and mortar stores, the mobile application may alert consumers that a certain number of the books may be released with aerial vehicles for purchase. The consumers may preorder the products or the products may be ordered from inflight aerial vehicles on demand at the preset launch time.

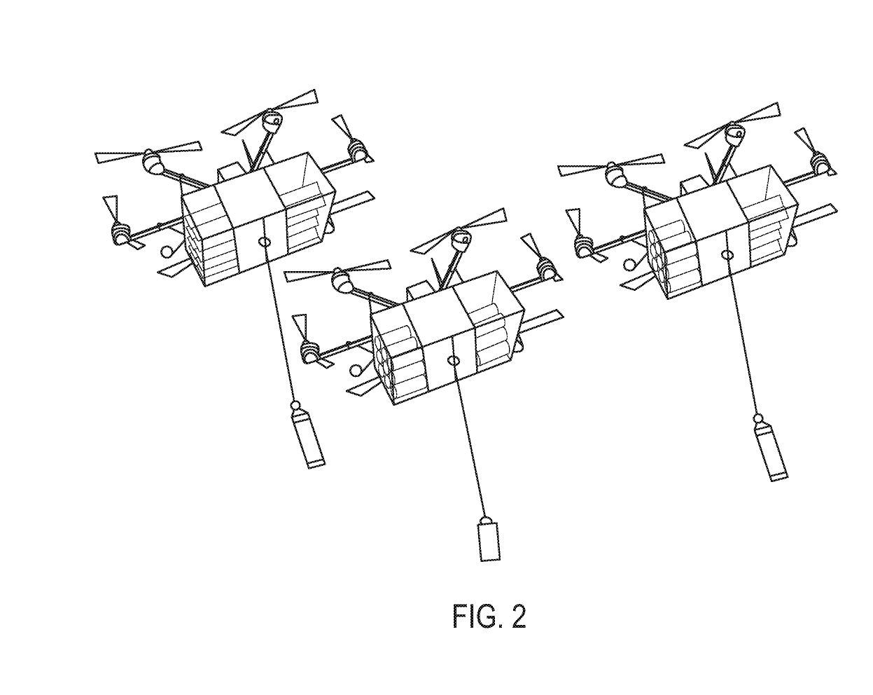

With reference to FIG. 2, the aerial vehicle may carry a single product or multiple products. An aerial vehicle may carry a dispenser that can handle multiple items frequently purchased together, such as a sandwich and beverage. An aerial vehicle may carry an array of different products, such as, for example, an array of chips, beverages, and/or candy. The product may be released as ordered by delivery types described herein or by conventional delivery methods. The array of products may be cataloged with codes or other identification tags such that the aerial vehicle may include a controller configured to select the proper product for delivery to the consumer. For example, the products may be aligned in a vending machine arrangement or in a wheeled or conveyor arrangement. When a consumer purchases an impulse product, the aerial vehicle may rotate the wheel or activate a spring to dispense the purchased product and deliver the same to the consumer. Such aerial vehicles may be specialized and dedicated to impulse products and may be optimized for such, for example, by including a vending machine arrangement, wheeled arrangement, soda dispenser, etc. The optimization may be a module which is coupled to an interior of the aerial vehicles. In this manner, aerial vehicles may, for example, be designated as a delivery vehicle or an impulse vehicle and specialized each day for the particular forecast of impulse and online deliveries expected for that day. The aerial vehicles may be thus be a flying vending machine, for example, carrying an array of candy bars (or other items) that may be released as ordered, by conventional delivery means, or by parachute or in a cushioned package that may be easily caught or can easily sustain a short drop.

Products carried by the aerial vehicle may include both primary products and secondary products. The primary product may be the impulse product purchased by the consumer. The secondary product may be a complementary product dispensed to the consumer to be used in conjunction with the primary product. For example, when a consumer purchases a hot dog, the aerial vehicle may also carry and dispense condiments, napkins, etc.

Products may be preloaded onto aerial vehicles by employees or by autonomous loaders. If an aerial vehicle is not scheduled for delivery or has available space on a delivery, the autonomous loader or employee may load high-demand or impulse products onto the aerial vehicle.

Aerial Vehicle

The aerial vehicles may have visual indicators, such as lights or flags. The lights may flash a particular color or pattern or the flag may be a particular color, either may be indicative of the product carried by the aerial vehicle. For example, the aerial vehicle may have a red flag or may flash lights in the color red to indicate the aerial vehicle carries soda. A second aerial vehicle may have a green flag or may flash lights in the color green to indicate the aerial vehicle carries umbrellas. One may appreciate that the aerial vehicle may be fitted with light emitting diodes (LEDs) or lights which are capable of flashing any color. In this manner, the aerial vehicle may carry multiple products and alternate flashing different colors. For example, where the aerial vehicle carries both soda and umbrellas, the aerial vehicle may alternate flashing lights between red and green. The aerial vehicle may spell, such as with a moving marquee sign, or otherwise symbolize the product(s) carried by the aerial vehicle.

A consumer seeing the particular color, symbol, sign, light, or flag may open an application on their mobile phone to purchase the product and receive delivery of same. Alternatively, the lights, colors, or pattern, may simply be indicative that the aerial vehicle is on an impulse flight. The consumer may see that lighted color and/or pattern and open the mobile application to see what the aerial vehicle is carrying and selling. The lighted color and/or pattern may be permanent and may be indicative of a product, flight, or function of the aerial vehicle that is unchanging. For example, an aerial vehicle may have a permanent function as a hot dog or ice cream delivery vehicle.

The aerial vehicle may have a base, such as a factory, store, warehouse, mothership, or shipping center, etc. The base may include a plurality of impulse products and a plurality of aerial vehicles. The base may act as a docking, recharging, and/or loading station for the impulse aerial vehicles. The base may be a delivery truck and the aerial vehicle may be stationed on the delivery truck during the delivery route for deployment based on a consumer impulse purchase along the delivery route.

As may be appreciated from disclosure, the aerial vehicle may be provided with onboard communication devices for communicating with the base, with the consumer mobile device, with recharging stations, or perches, etc. The aerial vehicle may include sensors, such as optical sensors, for verifying consumers and locating landing locations. The aerial vehicle may include communication devices and controllers for communicating with various components of the aerial vehicle, such as, for example, the delivery arrangement (cable, parachute, etc.) and vending arrangement (vending machine type spring-based product locator, wheel type product locator, lazy susan product locator, conveyor etc.), etc. as will be described herein.

Although the system and methods are described and depicted as being used with aerial vehicles, particularly unmanned aerial vehicles, it may be appreciated that the system and methods described herein may be applied to autonomous ground vehicles, manned ground vehicles, unmanned aerial vehicles, or manned aerial vehicles. The aerial vehicle may be a lighter than air (LTA) UAV.

Aerial Vehicle Delivery

The aerial vehicle may deliver to “close-enough” drop spots to complete the impulse sale. That is, the aerial vehicle may deliver to a spot that is close to the consumer but is safer or more convenient for the aerial vehicle and/or the consumer. The aerial vehicle may guide the buyer to the spot. Certain delivery locations (e.g. where the consumer is located) may not be suitable for delivery or may not be permitted for aerial vehicle delivery. For example, a densely vegetated park, a sporting stadium (which may be off limits to delivery during a game), or other areas prohibited by the Federal Aviation Administration (FAA) or other government agency. In the instance where delivery is prohibited or not possible, the aerial vehicle may communicate to the consumer (via the application) the nearest convenient and permissible location for delivery. This communication may occur prior to purchase by the consumer.

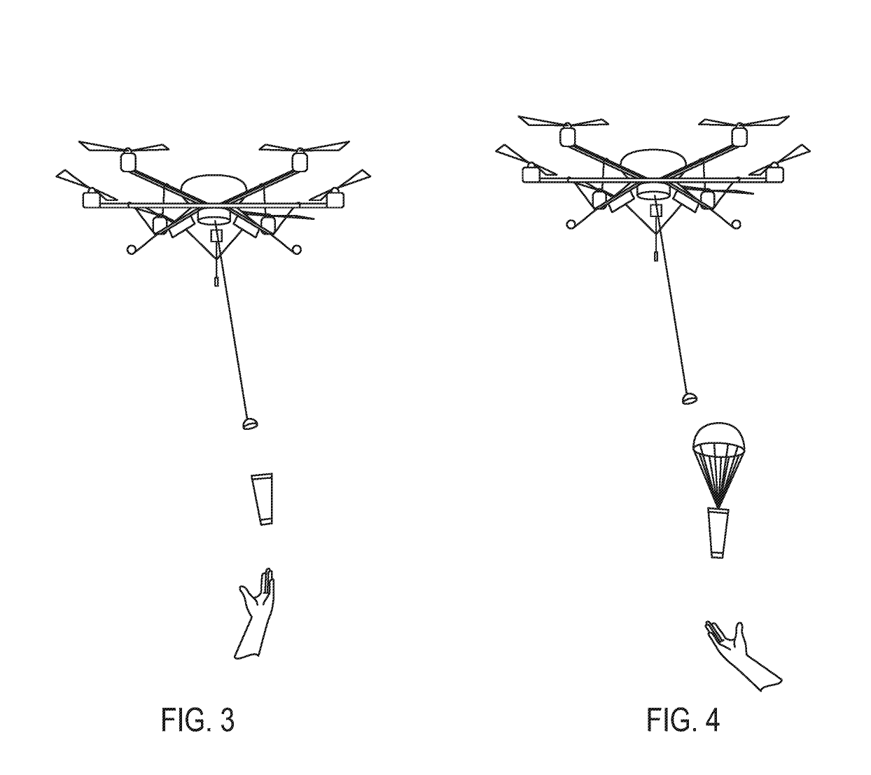

Referring to FIGS. 3 and 4, the aerial vehicle may deliver the product using a long cable or a parachute-provisioned package to deliver to the consumer's location. The use of cables and/or parachutes may allow delivery without requiring the UAV to fly dangerously low over public venues, crowded spaces, or densely vegetated places. If the aerial vehicle becomes proficient in delivery, and if the cable is of sufficient length, the aerial vehicle may be able to drop a product directly into a consumer's hand (FIG. 3). Using a long cable or a parachute to deliver to uncontrolled locations allow for delivery without requiring the aerial vehicle to fly dangerously low over what may be a public or crowded venue.

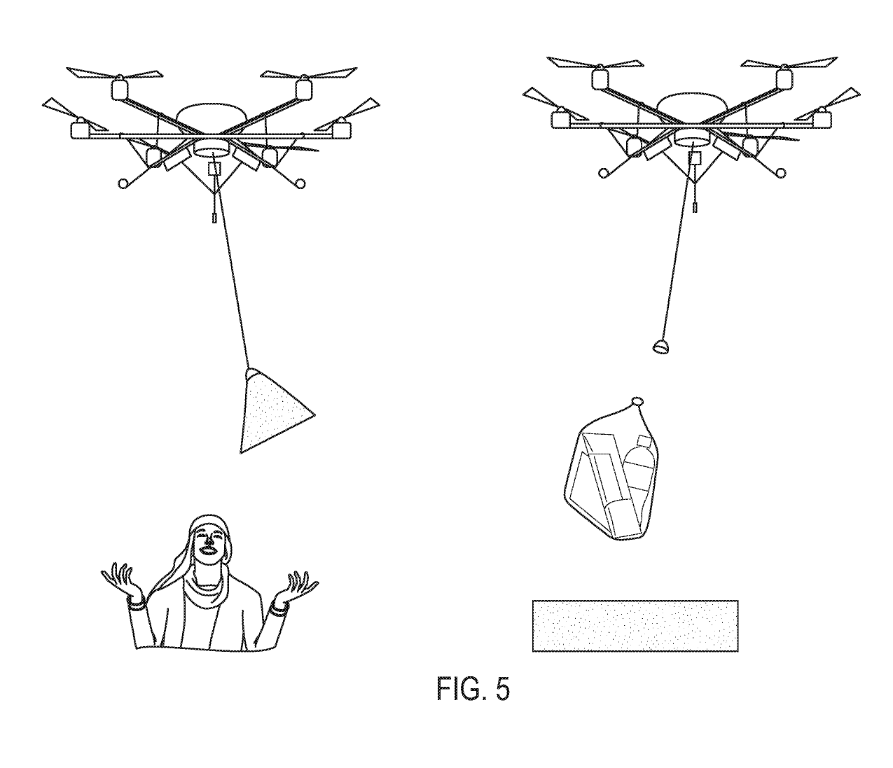

Referring to FIG. 5, the aerial vehicle may carry a landing pad or mat to be dropped by the aerial vehicle for delivery of the impulse product to the consumer. Alternatively, the consumer may carry a landing mat, which may be folded into a small profile to be deployed for delivery of the impulse product. The consumer may unfold the landing mat and deploy the landing mat in a suitable location. The aerial vehicle may have a sensor for sensing an image, code, or other identification on the mat. After identifying the location and placement of the landing mat, the aerial vehicle may drop the impulse product on the mat in one of the delivery methods described herein. For example, a customer may be in a park and may order a lunch while in a park. If the customer does not have a target mat, the aerial vehicle carrying the order may include a target mat. The aerial vehicle may drop the target mat (being allowed to free fall safely). The customer may open the target mat in a suitable place and the delivery of the product, targeting the target mat, may proceed.

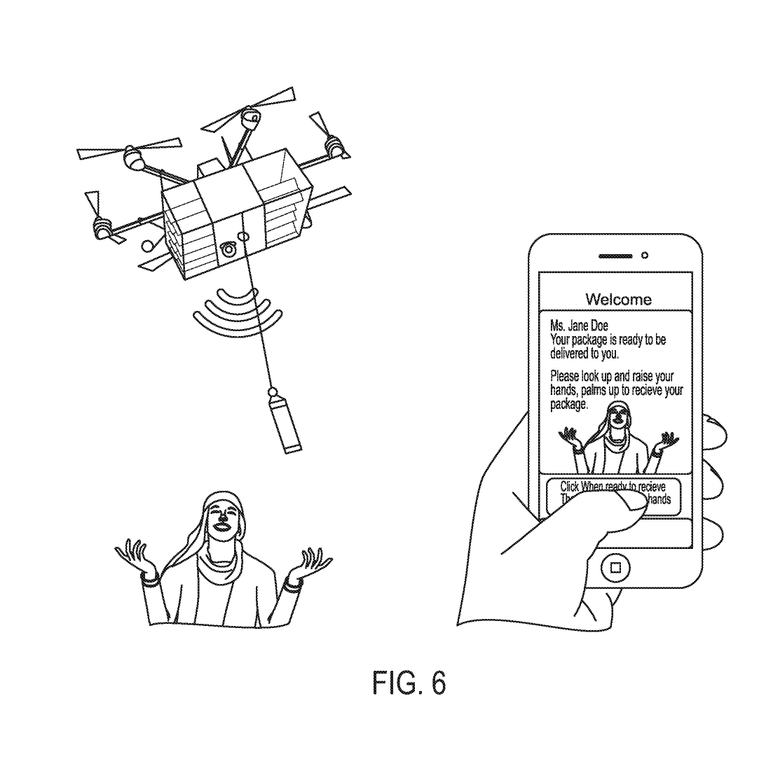

Referring to FIG. 6, the aerial vehicle may be responsive to the gestures of the target. For example, the consumer carrying a target mobile device (e.g. smart phone or tablet) may be looking upward with hands open and palms facing up. The aerial vehicle may have sensors to sense this gesture and may signal that the consumer is ready for delivery of the product. The aerial vehicle may release the product on a cable, by parachute, free-fall, or by other delivery methods.

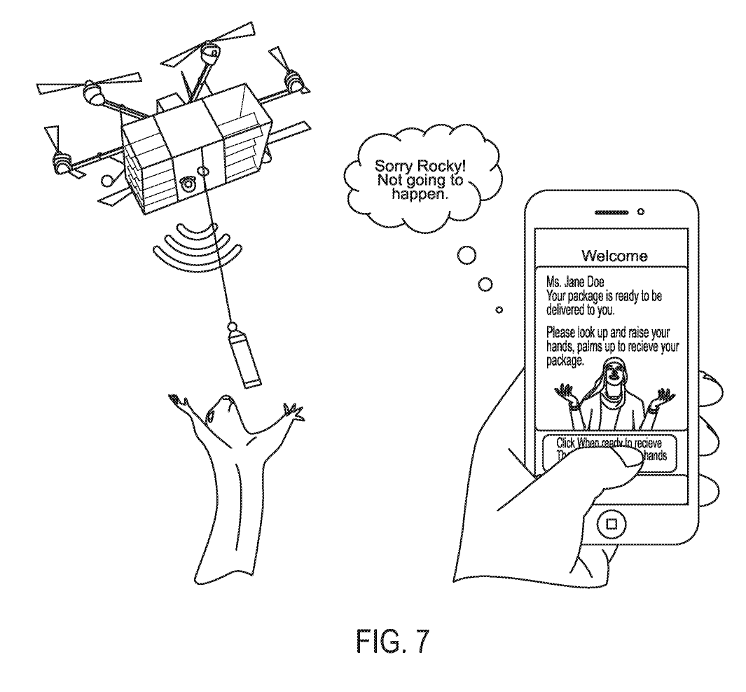

Referring to FIG. 7, the aerial vehicle may ensure the package is delivered to the purchasing consumer and is not intercepted by a third party. The aerial vehicle may use facial recognition scanners to determine the purchasing consumer receives the impulse product. No images may be stored in the aerial vehicle during this process. The aerial vehicle may send an image and/or audio file to the consumer. The consumer may hold the mobile device in such a manner that the aerial vehicle can see the image or hear the audio file to verify and authentic the proper consumer receives the impulse product. The aerial vehicle may using coding and/or IDs to confirm identity. The identifier may be a part of the mobile application. The identifier may be the geolocation of the mobile device, other feature of the mobile device, block chain, and/or a password.

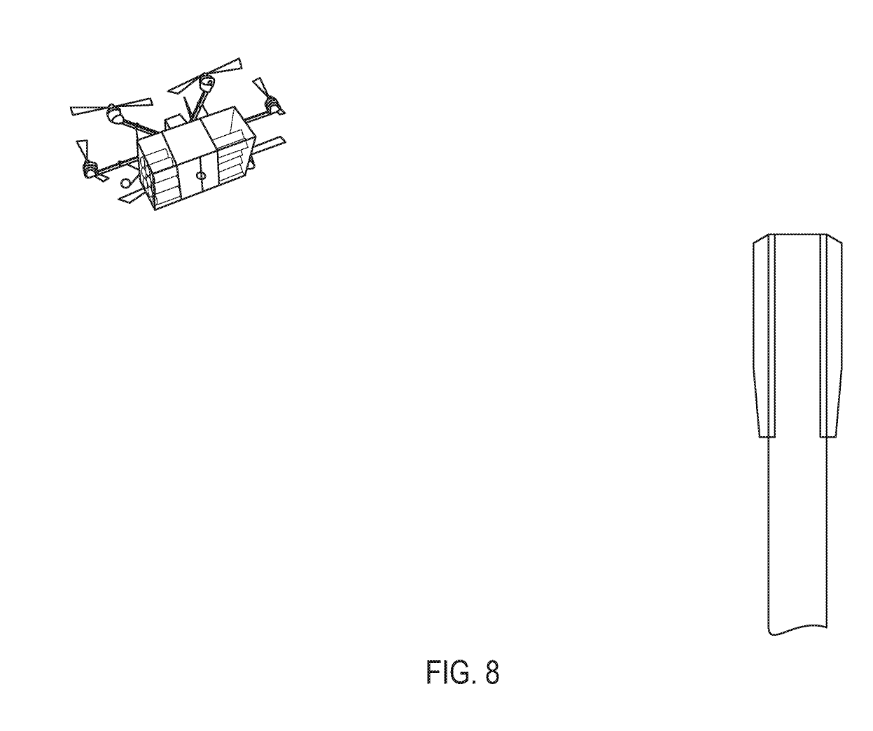

Referring to FIG. 8, the aerial vehicle may coordinate with a plurality of “perches” placed in predetermined locations. The perches may allow for the UAV to “perch” while waiting for a purchase of an impulse product instead of having the aerial vehicle in constant flight or hovering status. The predetermined locations for the perches may be selected based on high impulse purchase areas such that the transit time between the perch and a consumer is less than or equal to the time of an inflight aerial vehicle hovering near the high impulse purchase area.

Consumer Mobile Application

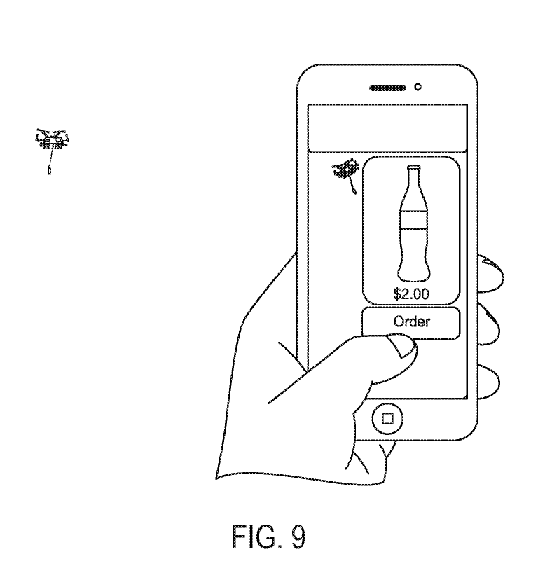

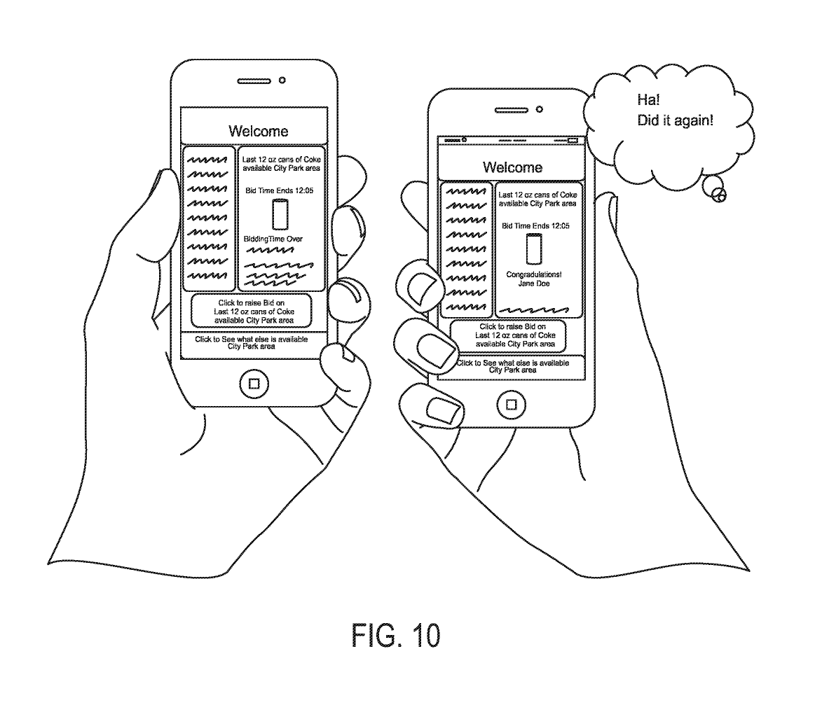

With reference to FIG. 9, the consumer's mobile device application (“app”) may depict a map or list of nearby aerial vehicles. The aerial vehicles may be tagged with a number or name for identification and/or selection by the consumer. The app may show the content of each aerial vehicle, the distance from the consumer, and the estimated delivery time. The consumer may further filter the aerial vehicles and/or products. That is, the consumer may instruct the app to filter for only aerial vehicles carrying, for example, soda or only aerial vehicles carrying umbrellas. Once filtered, the consumer may purchase the product. In some instances, the particular filtered product may not be available in an aerial vehicle in flight. The app may inform the consumer and provide the option of receiving delivery of the product after immediate shipment from the store. The app may inform the consumer of the estimated delivery time for shipment from the store. The shipment from the store may employ delivery methods and system otherwise used for impulse purchases as described herein. Thus, the consumer may still receive delivery the same day, with delivery delayed only slightly due to retrieval of the product from a store or other base and flight time of the impulse aerial vehicle. With reference to FIG. 10, the impulse runs may be dynamic. For example, bidding or auctioning of the items may be performed. Consumers may bid for products on their mobile apps and the aerial vehicle may deliver to the highest bidder.

The consumer's mobile device app may recognize that the consumer is a repeat or frequent consumer of impulse purchases. The consumer may be identified as a repeat or frequent consumer based on purchases made to the consumer, purchases made at that location and/or time, and/or purchase made at a particular event. A consumer identified in such a manner may receive priority over other impulse consumers or over scheduled online deliveries.

The consumer's mobile device app may also be used to indicate to the aerial vehicle that an impulse purchaser is near. The warehouse and/or aerial vehicle may monitor the location of impulse purchasers (via the mobile device app) and note where there is a congregation or larger group of impulse purchasers. The aerial vehicle may then use the location of the impulse purchasers as its destination and select an impulse product based on the particular location of the group of impulse purchasers. The aerial vehicle may be loaded with the impulse product and flown to the destination. Alternatively, the aerial vehicle may be redirected to this location. An alert may be sent to the mobile device app to indicate an aerial vehicle is on the way with a particular product and consumers may purchase the product. For example, the warehouse and/or aerial vehicle may note, based on geolocation of the mobile device obtained through the mobile app, that a group of impulse purchasers is at a beach. The aerial vehicle may be loaded with one or more appropriate impulse products (e.g. ice cream, beverage, suntan lotion, etc.) and may be directed to the beach. The aerial vehicle and/or warehouse may send the mobile device an alert that the aerial vehicle is arriving with those products for purchase.

Additionally, the mobile device app may send signals to the aerial vehicle and/or directly to a backend system at the warehouse (e.g. central computer system at the warehouse), as previously described. The aerial vehicle and/or warehouse may determine the density of the population of impulse purchasers at a particular location. The aerial vehicle may interface with the backend system to determine or identify if there is a strong potential for sales at that location. Alternatively, the backend system may identify the high potential for sales and launch aerial vehicles as necessary. For example, the backend system may know that customers nearly always buy ice cream at a park. The aerial vehicle may sense a high density of impulse purchasers at the park and communicate with the backend system. The backend system may send the information to the aerial vehicle that the park is a good place for ice cream sales and the aerial vehicle may be appropriately deployed in any of the described manners.

Aerial Vehicle Predictive Package Delivery System

The aerial vehicle package delivery system may be finely tailored to circumstances that may drive impulse purchases based on time, place, and situations (e.g. change in weather conditions), etc. The determination of impulse products, aerial vehicle routes, and/or number of aerial vehicles launched may be based on forecasting tools, aggregate customer value vectors, time of flight, a calculation of the value of each flight, regardless of load, and/or mobile device analytics. These factors may be balanced to determine if an impulse run is profitable and the impulse run may be tailored accordingly. As such, an aerial vehicle or fleet of aerial vehicles may be launched with products to locations that are selected based on events, locations, weather conditions, time, place, and other factors which effect the particular products purchased by consumers in those predetermined locations. The aerial vehicle(s) may have sensors to determine a congregation of consumers who have the mobile application which communicates with the aerial vehicle impulse delivery system. The aerial vehicle(s) may therefore have a higher likelihood of selling impulse products in this location.

Flight paths may be selected that proportionally bring the aerial vehicle closer to more consumers who have previously made impulse purchases. The number of aerial vehicles launched and the number of impulse products may be selected based on the same foregoing factors. For example, situations, such as rain or impending rain, may make launching aerial vehicles carrying foldable umbrellas or ponchos for immediate purchase profitable. The aerial vehicles may be repositioned throughout the day to maximize the amount of time the aerial vehicles are in locations with high concentrations of impulse product purchasing consumers.

The aerial vehicle delivery system and method described herein may be tasked or programmed to operate in a priority chain. For example, orders previously placed via computer, mobile device, or telephone placed in a conventional manner through a store website may take priority over impulse aerial vehicle launches. If a purchase pattern indicates forecasted impulse orders may be more profitable than secured online orders, particularly when online orders are less time-sensitive, the impulse aerial vehicle launches may take priority. Such a purchase pattern indicating a spike in impulse purchases may be, for example, during the lunch hour. After the surge or spike time has passed, online orders may be processed for delivery, again taking precedence over impulse purchases.

In addition to impulse purchases initiated by a consumer, the delivery system described herein may include push sales initiated by the mobile application. For example, if an aerial vehicle has been in flight for a predetermined period of time with no sale of the impulse product(s) the aerial vehicle carries, the mobile app may notify consumers located within a predetermined radius of the aerial vehicle that such a product is available for sale. The mobile app may further discount the product to push a consumer to purchase the impulse product. The predetermined period of time may be a period of time where profitability of the aerial vehicle delivery run is decreasing to or has decreased to an unprofitable level. Alternatively, the mobile app may inform consumers of certain products which are launched and in flight to the consumer's location. A consumer may set an alert on the mobile app to alert the consumer of a particular impulse product when the impulse product is in the area of the consumer. For example, the consumer may set an alert for sandwiches in flight during lunch. When a sandwich is loaded on an aerial vehicle nearby, the consumer may receive a text, e-mail, or in-app alert. The consumer may then purchase the product for delivery. The push type sales may operate to assist in the prediction of high impulse product sales come true by encouraging a consumer to purchase the product.

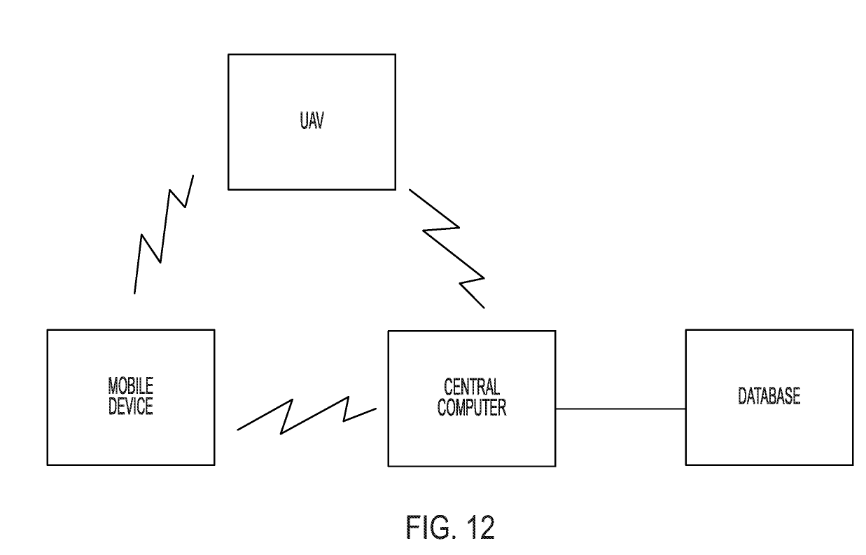

As may be appreciated from the foregoing, and from FIG. 12, the aerial vehicle may communicate with both the mobile device and a central computer (e.g. central computing system at the warehouse or other facility). The aerial vehicle may send and/or receive data and instructions from the mobile device and central computer. Likewise, the mobile device and may send and/or receive data and instructions from the aerial vehicle and central computer. And the central computer may send and/or receive data and instructions from the aerial vehicle and mobile device. The central computer may pull from a database of consumer information, sales data, product information, aerial vehicle information, etc. to predict the likelihood of certain products being sold to particular impulse purchasers in particular locations. The central computer may use this data to carry out the delivery system described herein.

As may be appreciated from the foregoing disclosure, predicting products and locations of delivery and thus preloading and pre-launching aerial vehicles removes the need to receive an order prior to launching an aerial vehicle. As such, down time of the aerial vehicles are minimized and profitability of an aerial vehicle delivery fleet may be optimized and increased. As may further be appreciated, any of the foregoing embodiments or variations may be employed with any of the other foregoing described embodiments to achieve the desired predictive aerial vehicle package delivery system.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

We claim:

1. A method for delivering a package, the method comprising:
loading a product onto a unmanned aerial vehicle (UAV);
launching the UAV and navigating the UAV to a delivery location;
communicating to a mobile device of a consumer at the delivery location the product loaded into the UAV;
preventing interception of the package by a third party; and
delivering the product to the consumer after the consumer purchases the product with the mobile device;
wherein the product is selected based on a prediction of high demand products for the delivery location, and
wherein delivering the product comprises sensing the consumer is in a receiving position and then lowering the product to the consumer.

2. The method of claim 1, wherein the product is determined based on at least one of a time of day, the delivery location, a number of consumers having a mobile device, weather conditions, event, or frequency of purchase.

3. The method of claim 1, wherein the delivery location is selected based on at least one of a prescheduled delivery route, cost of flight, length of flight, product, number of consumers having a mobile device, weather conditions, event, environmental condition, or frequency of purchases.

4. The method of claim 1, wherein communication to the mobile device comprises communicating from a communication device located on the aerial vehicle to the mobile device.

5. The method of claim 1, wherein communication to the mobile device comprises communicating a product to be purchased.

6. The method of claim 5, wherein communicating the product to be purchased comprises one or more of flashing lights, a marque sign, an audio cue, and a list in a mobile application.

7. The method of claim 1, wherein preventing interception of the package by a third party includes one or more of facial recognition, blockchain, geolocation, mobile device, identification code, or password.

8. The method of claim 1, wherein delivering the product to the consumer comprises one or more of lowering the product on a cable, dropping the product free-fall, dropping the product with a parachute, or dropping the product onto a landing mat.

9. A method for delivering a package, the method comprising:
loading a first product and a second product onto a unmanned aerial vehicle (UAV);
navigating the UAV to a first delivery location;
communicating to a consumer at the first delivery location that delivery of the first product is imminent;
preventing interception of the first product by a third party;
delivering the first product to the consumer;
navigating the UAV to a second delivery location;
communicating to one or more second consumers that the second product is available for purchase; and
delivering the second product to one of the one or more second consumer at the second delivery location after purchase of the second product by the one of the one or more second consumers,
wherein the second product, the second delivery location, or both are selected to optimize the profitability of the UAV and based on the probable value of purchase and delivery of the second product.

10. The method of claim 9, wherein optimization of profitability of the UAV is based on potential locations of the second delivery location, distance from a store, type of good for the second delivery location, time of day, weather, physical risk factors, statistics, who the one or more second consumers, space available in the UAV, flight time available, materials, risk, vehicle availability, vehicle condition, vehicle usage, battery life, station (location), energy, personnel, packaging, 3^{rd} party operator fees, tracking fees, UTM fees, premiums or discounts based on service level, or insurance, or combinations thereof.

11. The method of claim 9, wherein the second product or the second delivery location is selected based on at least one of a prescheduled delivery route, cost of flight, length of flight, product, number of consumers having a mobile device, weather conditions, event, environmental condition, or frequency of purchases.

12. The method of claim 9, wherein the first product is a plurality of first products and wherein delivery of the second product occurs after delivery of all of the plurality of first products.

13. The method of claim 9, wherein the first product is a plurality of first products and wherein delivery of the second product occurs before delivery of all of the plurality of first products or during delivery of the plurality of first products.

14. The method of claim 9, wherein the second product is ordered by another consumer while the UAV is in route to the first delivery location.

15. The method of claim 9, wherein the first product is a pre-ordered product and the second product is an impulse product.

16. The method of claim 9, wherein the UAV communicates with the consumer, a mobile device of a consumer, the first delivery location, the second delivery location or a combination thereof.

17. The method of claim 9, wherein preventing interception of the first product by a third party includes one or more of facial recognition, blockchain, geolocation, mobile device, identification code, or password.

18. The method of claim 9, wherein delivering the first product or the second product comprises one or more of lowering the product on a cable, dropping the product free-fall, dropping the product with a parachute, or dropping the product onto a landing mat.
